(19) United States
(12) Patent Application Publication
(10) Pub. No.: US 2025/0205017 A1
(43) Pub. Date: Jun. 26, 2025

(54) DENTAL APPLIANCES HAVING A TOOTH-GRIPPING FEATURE

(71) Applicant: Align Technology, Inc., San Jose, CA (US)

(72) Inventors: Iman SHOJAEI, San Jose, CA (US); Tzishing Jesse LIM, Mountain View, CA (US); Danial KIA, San Jose, CA (US); Syed Jameel ASKARI, San Jose, CA (US); Ken WU, San Jose, CA (US); Eric YAU, Santa Clara, CA (US); John Y. MORTON, San Jose, CA (US)

(21) Appl. No.: 19/000,592

(22) Filed: Dec. 23, 2024

Related U.S. Application Data
(60) Provisional application No. 63/614,512, filed on Dec. 22, 2023.

(51) Int. Cl. A61C 7/08; A61C 7/00; B33Y 50/00; B33Y 80/00

(52) U.S. Cl. CPC A61C 7/08; A61C 7/002; B33Y 50/00; B33Y 80/00

(57) ABSTRACT

Methods and apparatuses for increasing the effectiveness dental appliances in gripping and manipulating teeth. These methods and apparatuses may include one or more (e.g., a series of) dental appliances that may include a radial grip that improves the contact and allows the application of normal and friction forces between a patient's teeth and aligner without disrupting the fit of the overall aligner.

### CLAIM OF PRIORITY

This patent application claims priority to U.S. provisional patent application No. 63/614,512, titled “DENTAL APPLIANCES HAVING A TOOTH-GRIPPING FEATURE,” and filed on Dec. 22, 2023, herein incorporated by reference in its entirety.

### BACKGROUND

Orthodontic treatment is often recommended for dental patients having teeth that are improperly positioned. Orthodontic treatment can greatly improve the aesthetic appearance of the patient, especially in regions near the front of the oral cavity. Orthodontic treatment can also enhance the function of the teeth by enabling opposing teeth to better interact with each other during mastication. Patient-removable dental appliances, such as polymeric shell aligners, may be used to move one or more teeth as part of an orthodontic treatment. However, some tooth movements, and in particular tooth rotation and intrusion/extrusion movements may be challenging using patient-removable dental appliances, as it may be difficult to achieve sufficient purchase, e.g., grip, on the teeth without bonding one or more materials to the teeth. What is needed are dental appliances and methods that may improve the ability to achieve these other-wise difficult tooth movements. The methods and apparatuses described herein may address these needs.

### SUMMARY OF THE DISCLOSURE

Described herein are methods and apparatuses, e.g., devices and systems (including hardware, software and/or firmware) for increasing the effectiveness dental appliances in gripping and manipulating teeth. In particular these methods and apparatuses may include one or more (e.g., a series of) dental appliances that may include a radial grip that improves the contact and allows the application of normal and friction forces between a patient's teeth and aligner without disrupting the fit of the overall aligner. The radial grips described herein are grabbing features that may assist the dental appliance in grabbing and holding the teeth (e.g., crown region of the tooth). The radial grips may be part of one tooth-receiving region of a dental appliance (or in some cases more than one); compared to other tooth-receiving regions of the dental appliance the radial grip may apply a radially-inward, or constricting, force on the tooth, grabbing the tooth, in addition to a force to translate and/or rotate the tooth. The radial grips described herein may be integrated into the dental appliance, e.g., as a projection within the tooth-receiving region of the dental appliance. A radial grip may help tightly grab and hold the tooth and may assist in staging of the dental treatment, including reducing the number of stages. The radial grips described herein may allow the application of normal forces and resulting tooth movements that have not previously been possible using a removable dental appliance, particularly without the use of attachments. The radial grips described herein may be configured to allow the dental appliance to be applied to the teeth easily, despite the use of radial force gripping one or more of the patient's teeth when the device is applied.

The methods and apparatuses described herein may include one or more radial grips that is configured to reducing sliding of the dental appliance on tooth surface, and instead more efficiently transfers the force (e.g., the energy) being applied by the dental appliance to the tooth. These radial grips may therefore reduce the tooth-aligner gap, may increase the contact and normal forces applied by the dental appliance to the tooth or teeth, and may permit relatively larger frictional forces between the tooth-receiving region of the dental appliance and the tooth.

In general, it would be beneficial to securely couple a dental appliance to the one or more teeth to be acted upon during a particular stage of a dental appliance. Typically a force is applied by the dental appliance to one or more teeth during a treatment stage in order drive movement of that one or more tooth relative to the other teeth, by forming the tooth-receiving portion of the dental appliance such that there is sufficient room in the dental appliance to allow the tooth to move into the target location for the particular stage. This may mean that the tooth tooth-receiving cavity applies force to one side or portion of the tooth, without applying significant force on the opposite side of the tooth, which would oppose the movement of the tooth in the target direction; in some cases this may mean that a gap or space is present between the tooth and the inside surface of the tooth-receiving cavity in the intended direction of translation of the tooth.

The radial grips described herein may comprise one or more projections into the tooth-receiving region (“tooth-receiving cavity”) of the dental appliance. As used herein a dental appliance may include any appropriate orthodontic device, including but not limited to a dental aligner, palatal expander, etc. The one or more projections may apply a radially-inward force to grip the teeth; additional forces for moving (e.g., translating and/or rotating) the teeth may also be applied through the one or more radial grips. The radial grip may be configured to prevent pop-off of the dental appliance due to the constricting force, and may be configured so that the he dental appliance can be easily applied, and removed while securely engaging the teeth, including the one or more teeth gripped with a radial grip.

The radial grip may include a projection region on the buccal and lingual sides of the tooth-engaging region of the dental appliance. The radial grip may be distributed around the inner surface of the tooth-engaging region of the dental appliance so that at least a constricting force is applied to grip the tooth within the tooth-engaging region, so that the radial grip applies a constricting force around the tooth. In some examples the radial grip may cover at least about 40% of the inside of the tooth-receiving cavity (e.g., at least about 45%, at least about 50%, at least about 55%, at least about 60%, etc.). Increasing the coverage of the radial grip relative to the tooth may allow for a significant gripping force while avoiding or reducing the likelihood of pop off, e.g., the likelihood that the device will be driven off of the tooth. In some examples the radial grip may extend proud of the rest of the inner surface of the tooth-receiving cavity by, e.g., about 0.1 mm or more (e.g., 0.2 mm or more, 0.3 mm or more, 0.4 mm or more, etc.), or more particularly, between about 0.1 mm and 0.7 mm (e.g., between about 0.2 mm and 0.7 mm, between about 0.2 mm and 0.6 mm, etc.). The prominence of the radial grip may have rounded or squared-off edges.

For example, described herein are orthodontic devices comprising: a body comprising a plurality of tooth-receiving cavities having a first shape corresponding to a target dental arch position, wherein the body applies a first orthodontic force against one or more target teeth of a dental arch of a patient, wherein said first orthodontic force generates movement of said one or more target teeth toward a target tooth position corresponding to the target dental arch position; wherein a tooth-receiving cavity of the plurality of tooth receiving cavities includes a radial grip comprising one or more projections arranged around a radius of an interior of the tooth-receiving cavity configured to apply a net radially inward force on a tooth held within the tooth-receiving cavity, further wherein the radial grip extends between 20% and 90% of an inner surface of the interior of the tooth-receiving cavity.

The one or more projections may have a prominence relative to the inner surface that is between about 0.1 mm and 0.7 mm (e.g., between about 0.2 mm and 0.6 mm). The prominence may refer to the extent to which the radial grip extends proud of the inner surface of the tooth-receiving region. In particular, the prominence may extend proud of the other regions of the same tooth-receiving region or of the tooth-receiving regions adapted for other teeth in the same orthodontic device.

In some examples the radial grip may comprise a band extending around the interior of the tooth-receiving cavity. Alternatively or additionally, the radial grip may comprise a plurality of projections arranged with approximately equal spacing (and in some cases, symmetrically) around the interior of the tooth-receiving cavity. For example, the one or more projections arranged around the radius of the interior of the tooth-receiving cavity may be on a buccal side and a lingual side of the interior of the tooth-receiving cavity. The radial grip may extend between about 30% and 80% of the inner surface of the interior of the tooth-receiving cavity (e.g., between about 30% and 75%, between about 35% and 75%, between about 40% and 70%, etc.),

The radial grip may have a rounded or curved edge, or in some examples, a tapered edge. The radial grip may include a textured surface or a surface that is relatively smooth. In some cases it may be particularly advantageous to provide a smooth surface that is configured to conform to the surface of the tooth when the tooth is seated fully into the tooth-receiving cavity. The first orthodontic force may be applied in addition to the net radially inward force; the net radially inward force may be a gripping (e.g., constricting) force on the tooth. The additional, orthodontic force, may be configured to move the tooth relative to the other teeth of the dental arch, e.g., in translation (including tipping, anterior/posterior movement, etc.) and/or rotation.

For example, an orthodontic device may include: a body comprising a plurality of tooth-receiving cavities having a first shape corresponding to a target dental arch position, wherein the body applies a first orthodontic force against one or more target teeth of a dental arch of a patient, wherein said first orthodontic force generates movement of said one or more target teeth toward a target tooth position corresponding to the target dental arch position; wherein at least one tooth receiving cavity of the plurality of tooth receiving cavities includes a radial grip comprising one or more projections arranged around a radius of an interior of the at least one tooth-receiving cavity to apply a net radially inward force on a tooth held within the at least one tooth-receiving cavity, further wherein the radial grip extends between 30% and 80% of an inner surface of the interior of the at least one tooth-receiving cavity, further wherein the one or more projections has a prominence relative to the inner surface of between about 0.1 mm and 0.7 mm.

Also described herein are methods of using and methods of forming any of these apparatuses. For example, described herein are method of forming an orthodontic device for a patient, the method comprising: receiving or forming a digital model of the patient's dental arch, including the patient's teeth; modeling an orthodontic device body, based on the digital model of the patient's teeth, the orthodontic device body comprising a plurality of tooth-receiving cavities that are configured to engage with a plurality of teeth of the patient's dental arch; configuring the model of the orthodontic device body so that the orthodontic device body applies a first orthodontic force against one or more target teeth of the patient's dental arch when the orthodontic device body is worn on the patient's teeth, wherein said first orthodontic force generates movement of said one or more target teeth toward a target tooth position corresponding to a target dental arch position; modeling a radial grip comprising one or more projections around a radius of an interior of the tooth-receiving cavity to apply a net radially inward force on a tooth held within the tooth-receiving cavity, further wherein the radial grip extends between 20% and 90% of an inner surface of the interior of the tooth-receiving cavity; and fabricating the orthodontic device.

As used herein, fabricating may include preparing a digital file with the design of the orthodontic device that may be used for automatic fabrication, e.g., by a three-dimensional (3D) fabrication technique, such as, but not limited to, 3D printing, e.g., vat photopolymerization, material jetting, light polymerization (e.g., stereolithography/SLA, digital light processing (DLP), continuous liquid interface production (CLIP), etc.), binder jetting, powder bed fusion (e.g., laser metal deposition (LMD), electron beam melting (EBM), selective laser melting (SLM), selective heat sintering (SHS), direct metal laser sintering (DMLS), etc.), material extrusion (e.g., direct ink writing (DIW), extrusion based additive manufacturing, etc.), directed energy deposition, and/or sheet lamination. For example, fabricating may include exporting a digital file comprising the model of the orthodontic device including the radial grip. In some examples, fabrication may mean preparing and/or outputting the digital file with the design of the orthodontic device. In some examples, fabrication may include forming the orthodontic appliance (e.g., aligner). The orthodontic appliance may be fabricated by 3D printing.

In any of these methods the radial grip may be modeled. Modeling the radial grip may include modifying a model of the orthodontic device body to include the model of the radial grip.

As mentioned, the one or more projections of the radial grip may have a prominence relative to the inner surface of between about 0.1 mm and 0.7 mm. In some examples, the method may include setting the height and/or curvature (e.g., of the edge) and/or the location, and/or the extent of the prominence so that the radial grip applies a constrictive force to the tooth but does not result in pop-off of the orthodontic appliance from the tooth. In some cases the one or more projections of the radial grip may have a prominence relative to the inner surface of the tooth-receiving region that is between about 0.2 mm and 0.6 mm. In any of these methods the radial grip may be arranged as a band extending around the interior of the tooth-receiving cavity. The radial grip may be arranged as a plurality of projections positioned symmetrically around the interior of the tooth-receiving cavity. The one or more projections may be arranged around the radius of the interior of the tooth-receiving cavity on a buccal side and on a lingual side of the interior of the tooth-receiving cavity.

The radial grip may extend between about 30% and 80% (e.g., between about 30% and 75%, between about 35% and 70%, between about 35% and 80%, between about 35% and 75%, between about 40% and 70%, between about 40% and 80%, between about 40% and 75%, etc.) of the inner surface of the interior of the tooth-receiving cavity. The method may include forming the edge(s) of the radial grip, e.g., the prominence. For example, the edges may be rounded.

Any of these methods may forming the surface of the radial grip. In some cases forming the surface of the radial grip may include adding a texture to the radial grip surface. The texture may be smooth or rough (e.g., bumpy, ridged, etc.). The texture may include a pattern (such as a grid, honeycomb, etc.).

In general, any of the methods described herein may include configuring the radial grip so that the radial grip applies an appropriate constriction force on the tooth while also applying a force to move (e.g., translate, tip, rotate, etc.) the tooth in accordance with a treatment plan to reposition to teeth (e.g., applying an orthodontic force). The orthodontic force may be applied in addition to the net radially inward force (constricting force). The magnitude and direction of the orthodontic force may be adjusted, selected and/or modified because the radial grip may securely engage the tooth with the orthodontic device.

For example, described herein are apparatuses, including systems, for performing any of these methods. A system may include: one or more processors and a memory coupled to the one or more processors, the memory storing computer-program instructions, that, when executed by the one or more processors, perform a method comprising: receiving or forming a digital model of the patient's dental arch, including the patient's teeth; modeling an orthodontic device body, based on the digital model of the patient's teeth, the orthodontic device body comprising a plurality of tooth-receiving cavities that are configured to engage with a plurality of teeth of the patient's dental arch; configuring model of the orthodontic device body so that the orthodontic device body applies a first orthodontic force against one or more target teeth of the patient's dental arch when the orthodontic device body is worn on the patient's teeth, wherein said first orthodontic force generates movement of said one or more target teeth toward a target tooth position corresponding to a target dental arch position; modeling a radial grip comprising one or more projections around a radius of an interior of the tooth-receiving cavity to apply a net radially inward force on a tooth held within the tooth-receiving cavity, further wherein the radial grip extends between 20% and 90% of an inner surface of the interior of the tooth-receiving cavity; and, in some cases, fabricating the orthodontic device body,

As mentioned, the radial grips may be part of one tooth-receiving region of a dental appliance (or in some cases more than one); compared to other tooth-receiving regions of the dental appliance the radial grip may apply a radially-inward force on the tooth (grabbing the tooth) in addition to a force to translate and/or rotate the tooth. The radially inward force may be a constricting force, that may be a net gripping force distributed over the outer circumference of the tooth and may be oriented radially inward in the plane of the tooth. The radial inward (constricting) force may be configured to prevent “pop off” of the dental appliance, as described herein. The radially inward (constricting) force may be applied radially around the circumference of the tooth in a balanced manner, so that the radial grip, applies a net radially-inward force to grip the tooth that is, e.g., between about 0.1N and 40 N.

In some examples a method may include: receiving or generating a 3D model of a subject's dentition based on an intraoral scan of the subject's dentition, wherein the subject's dentition is in a first arrangement; receiving or generating a treatment plan comprising a plurality of stages, wherein the treatment plan is configured to move a subject's dentition from the first arrangement toward a target arrangement; identifying a tooth displacement between two stages of the plurality of stages of the treatment plan; using the tooth displacement to identify aligner interaction forces between the subject's dentition and an aligner; identifying one or more pressure regions to apply pressure on the subject's dentition to manage the aligner interaction forces; identifying one or more gripping areas to implement the one or more pressure regions; generating an aligner corresponding to one of the two stages having the one or more gripping areas to achieve the displacement.

Any of these methods may include receiving the intraoral scan of a subject's dentition. Identifying the one or more gripping areas may comprise identifying the one or more gripping areas within an interior of a tooth-receiving cavity of the aligner that is between 20% and 90% of an inner surface of the interior of the tooth-receiving cavity. Any of these methods may include identifying the second arrangement of the subject's dentition using a manipulation of the 3D model. The treatment plan may include a plurality of intermediate arrangements to move the subject's dentition from the first arrangement toward the target arrangement.

In general, aligner interaction forces may include contact forces, normal forces, friction forces, or some combination thereof. Managing the aligner interaction forces may comprise reducing the aligner interaction forces.

The gripping areas may be modeled as one or more bands around the specific tooth.

Any of these methods may include using the one or more gripping areas and the displacement to define one more gripping components by modifying the displacement of the specific tooth receiving cavity.

Generating the aligner may comprise providing instructions to make an aligner with the one or more gripping component. For example, generating the aligner may comprise fabricating the aligner. Fabricating the aligner may comprise thermoforming the aligner, and/or three-dimensional (3D) printing the aligner. The gripping component may be integral to the tooth receiving cavity of the aligner.

The gripping component may comprise a region of increased contact between the subject's dentition and the aligner.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1A shows one example of a dental appliance (e.g., an orthodontic device) including a radial grip within a tooth receiving cavity of the dental appliance.

FIG. 1B schematically illustrates a section through the dental appliance of FIG. 1, showing the radial grip.

FIG. 1C schematically illustrates a section through a dental appliance similar to that shown in FIG. 1A without the radial grip, for comparison.

FIG. 1D illustrates one example of a model of a tooth showing just the radial grip on the tooth.

FIG. 2A is a digital model of a dental arch including a tooth showing a radial grip portion of an orthodontic device arranged on the tooth (the rest of the orthodontic device is not shown). In FIG. 2A the digital model of the dental arch is shown segmented with tooth numbers identified.

FIGS. 2B-2D illustrate the tooth of FIG. 2A including the attached radial grip, in which just the radial grip portion of the dental appliance is shown; the rest of the dental appliance has been made invisible. FIG. 2B is a buccal view, FIG. 2C is a lingual view, and FIG. 2D is a side view.

FIGS. 3A-3B show an example of a digital model of a portion of a patient's dental arch including a canine tooth having a radial grip configured to assist with z-rotation and extrusion of the tooth. In FIG. 3A shows the buccal view and FIG. 3B shows the lingual view.

FIGS. 4A-4B show an example of a digital model of a portion of a patient's dental arch including the MDRC (mesio-distal right canine) illustrating a radial grip configured to assist with z-rotation and extrusion of the tooth, while preventing tipping. FIG. 4A shows a buccal view and FIG. 4B shows a lingual view.

FIGS. 5A-5B illustrate an example of a digital model of a portion of a patient's dental arch showing an isolated radial grip portion of an orthodontic device. FIG. 5A shows the buccal view and FIG. 5B shows an occlusal view.

FIG. 6 shows an example of a model (e.g., an SLA mold model) that may be used to form an orthodontic appliance including a radial grip.

FIGS. 7A-7B illustrate examples of models for forming dental appliances including radial grips having different dimensions, including different edge curvatures for the radial grip portions.

FIG. 8 is an example of a dental appliance including a radial grip formed within a tooth-receiving region.

FIG. 9A shows another example of a dental appliance including a radial grip formed within a tooth-receiving region. FIG. 9B shows a digital model of just the radial grip region on a patient's tooth.

FIG. 10A shows another example of a dental appliance including a radial grip formed within a tooth-receiving region. FIG. 10B shows a digital model of just the radial grip region on a patient's tooth.

FIG. 11 schematically illustrates one example of a method of forming a dental appliance (e.g., an orthodontic device) including a radial grip region as described herein.

FIG. 12 schematically illustrates another example of a method of forming a dental appliance including a radial grip region as described herein.

### DETAILED DESCRIPTION

Any of the dental appliances described herein may include one or more radial grips formed as part of (or coupled to) the tooth-receiving portion of the dental appliance. The radial grips may circumferentially hold the tooth so that the dental appliance may more reliably provide a normal force to the tooth. Thus, the radial grip region may apply a constrictive (e.g., radially inward) force on the tooth. This may be achieved without the need for an attachment bonded to the tooth, as the radial grip may act as a tightening or grabbing feature that increases the contact, and therefore normal and frictional forces, between the tooth and the dental appliance. Thus, these dental appliances may generate significant forces on the tooth in any direction.

Typically, the smooth and relatively uniform surface of most teeth causes limitations for generating forces/movements in some directions. The lack of desired normal surfaces on teeth may limit the ability of removable (e.g., patient-removable) dental appliances that are not otherwise coupled to the teeth, to move teeth in order to achieve movements such as extrusion, rotation around z axis, and preventing tipping. These extrusion, rotation and anti-tipping forces may not be effectively generated without the use of attachments bonded to the teeth. The friction between the patient's teeth and the dental appliance (e.g., aligner) may be relatively small, which may be another challenge, particularly given the shapes of some teeth.

Most removable dental appliances include a gap or space between the patient's teeth on at least one side of the tooth when the appliance is worn, particularly for teeth that are being actively moved by the appliance, in order to allow space to direct movement of the tooth. This gap or space may have the benefit of allowing the device to be easily applied and may assist in retaining the appliance on the teeth during wear. In general, if the fit of the dental appliance is too tight relative to the patient's teeth, the aligner may be difficult to apply, and may have trouble staying on the teeth, resulting in a condition referred to as “pop off” in which the dental appliance comes off of the teeth.

The methods and apparatuses described herein may provide dental appliances in which one or more (e.g., two, three, four, etc.) of the tooth-receiving regions (or “cavities”) of a patient-removable dental appliance include a radial grip that is configured to apply a constrictive (radially inward) force on the tooth when the appliance is worn, improving the ability to move the particular tooth held by the radial grip. The radial grip and the dental appliance may be configured specifically so that the dental appliance may be removably worn the patient while minimizing the risk of pop-off, and may be relatively easy to put on and take off. In addition to the radially inward (e.g., constrictive) force, the radial grip may assist in applying forces to move the tooth held by the radial grip relative to the other teeth held by the dental appliance, e.g., to provide translational, rotation and/or intrusion/extrusion forces.

The radial grips described herein may be included in any appropriate patient-removable dental appliance, and in particular orthodontic dental appliances, such as aligners, palatal expanders, retainers, etc. In many of the examples described herein, only a single tooth-receiving region of a dental appliance includes a radial grip. It should be understood that more than one of the tooth-receiving region of a patient-removably dental appliance may include a radial grip

In general, a gap between a tooth and a dental appliance can significantly reduce the normal force, N, between tooth and the dental appliance and, in turn, reduces the friction force (f=μN, where μ is the coefficient of friction). A large enough friction force between tooth and the dental appliance can help generate movements such as extrusion without the need for an attachment on the tooth. While most efforts towards increasing the friction force have been focused on the coefficient of friction, μ, the role of normal force, N, in improving the friction force has usually been overlooked. Another drawback of large gaps between tooth and the dental appliance is that staging becomes less effective; especially in large rotations around the three axes. In such cases, because of large gaps between tooth and the dental appliance, instead of transferring the energy from aligner to tooth, the aligner may slide on the tooth and the force may be reduced or misplaced.

The radial grips described herein may increase the contact, normal, and friction forces between teeth and the dental appliance. These radial grips may be referred to as grabbing features and generally include multiple pressure points all around a tooth in order to tightly grab and hold the tooth such that staging (e.g., during a dental treatment plan) can effectively move the tooth.

A radial grip is configured to apply a constrictive force around the circumference of the tooth to grip the tooth. This gripping force may be balanced, based on the shape and size of the radial grip, as described herein, to prevent pop-off, while significantly increasing the normal force between the tooth and the dental appliance. Thus, the radial grips described herein are configured to apply force from multiple regions around the circumference of the crown region of the tooth to constrict the tooth. In some examples the radial grip may include both buccal and lingual contact regions. In some cases the contact regions may be arranged around the circumference of the tooth. In any of these apparatuses the radial grip may be configured to contact a significant portion, e.g., 30% or more, 35% or more, 40% or more, 45% or more, 50% or more, 55% or more, 60% or more, 65% or more, 70% or more, etc. (e.g., between 30%-80%, between 35% and 75%, between 40%-70%, between 40% and 60%, etc.) of the crown of the tooth held within the tooth-receiving region.

The radial grip may be formed as one or more projections into the tooth-receiving region of the dental appliance that is configured to contact the tooth when the patient-removable dental appliance is worn. The one or more projections may have a prominence that extends from the wall of the tooth receiving region. The height of the prominence, e.g., extending from the wall of the tooth-receiving region, may be selected to provide sufficient gripping force while minimizing the likelihood of pop off. For example, the height of the prominence may be between about 0.1 mm to about 0.7 mm (e.g., between about 0.1 mm to about 0.6 mm, between about 0.2 mm to about 0.6 mm, between about 0.2 mm to about 0.5 mm, between about 0.1 mm to 0.5 mm, between about 0.3 mm to 0.5 mm, etc.).

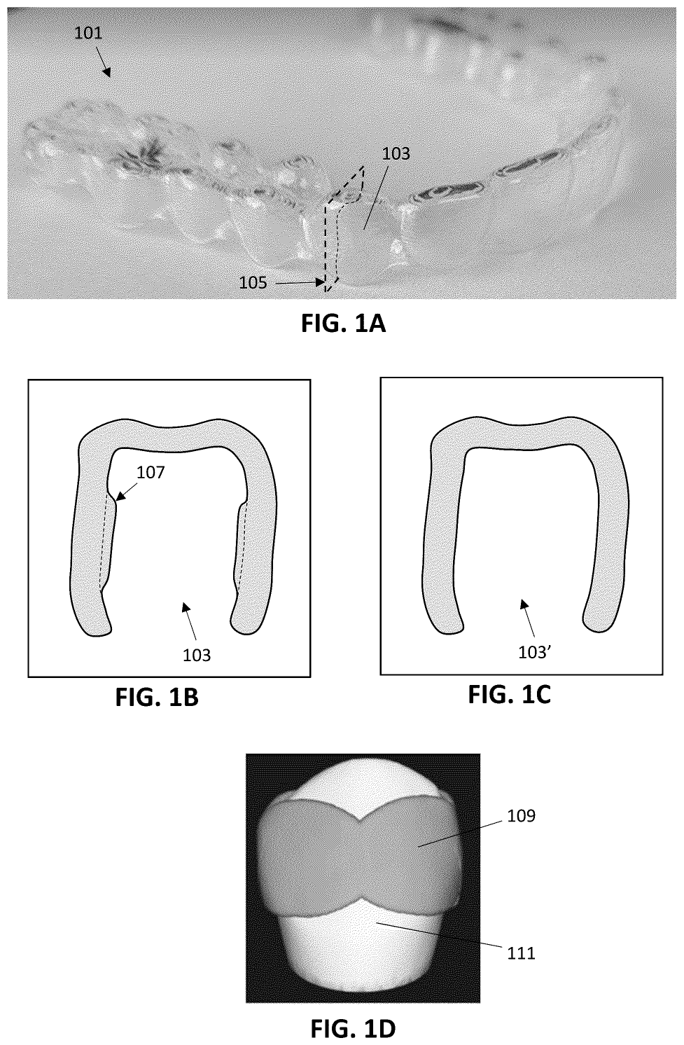

FIGS. 1A-1D illustrates one example of a dental appliance 101 including a radial grip 107 within a tooth-receiving region 103 of the dental appliance. In FIG. 1A the dental appliance 101 is shown including a plurality of tooth receiving cavities formed as a polymeric shell appliance that is configured to be worn over the patient's teeth. The appliance is formed of a polymeric material having lingual, occlusal and buccal surfaces, comprising a plurality of interconnected tooth-receiving regions (cavities). This appliance may be one of a series of dental appliances that may be worn by the patient. In this example only one tooth-receiving cavity 1003 of the plurality of tooth-receiving cavities includes a radial grip. The radial grip is illustrated as a section 105 through the tooth-receiving cavity 103 in FIG. 1A, and is shown in FIG. 1B. In FIG. 1B the section though the dental appliance shows the prominence forming the radial grip 107 on the buccal and lingual sides of the tooth receiving cavity. The tooth-receiving cavity 103 includes inner sidewalls, and the radial grip extends proud of these sidewalls, as shown by the dashed lines. FIG. 1D illustrates just the (isolated) radial grip of FIGS. 1A and 1B shown contacting a tooth 111, e.g., when the dental appliance 101 is worn by the patient. As shown in FIG. 1D, the radial grip region extends over and contacts much of the surface of the tooth 111. The radial grip may apply a constrictive force on the tooth that may allow movement of the tooth by the dental appliance, such as extrusion, rotation and translation (including anti-tipping) movements. In FIG. 1D the majority of the surface of the tooth within the tooth-receiving cavity (e.g., >50%) is in contact with the radial grip.

FIG. 1C illustrates an example of a section through a dental appliance otherwise identical to the dental appliance of FIG. 1A and 1B, but without the radial grip. In this example the tooth-receiving cavity 103′ does not include any prominence forming the radial grip.

### EXAMPLES

Performance of the various radial grips were tested and found to provide exceptional control and improved ability to provide anterior extrusion, canine z rotation, and MDRC anti-tipping (all without attachments). Significant improvements were observed in the force system for dental appliances with radial grips versus controls.

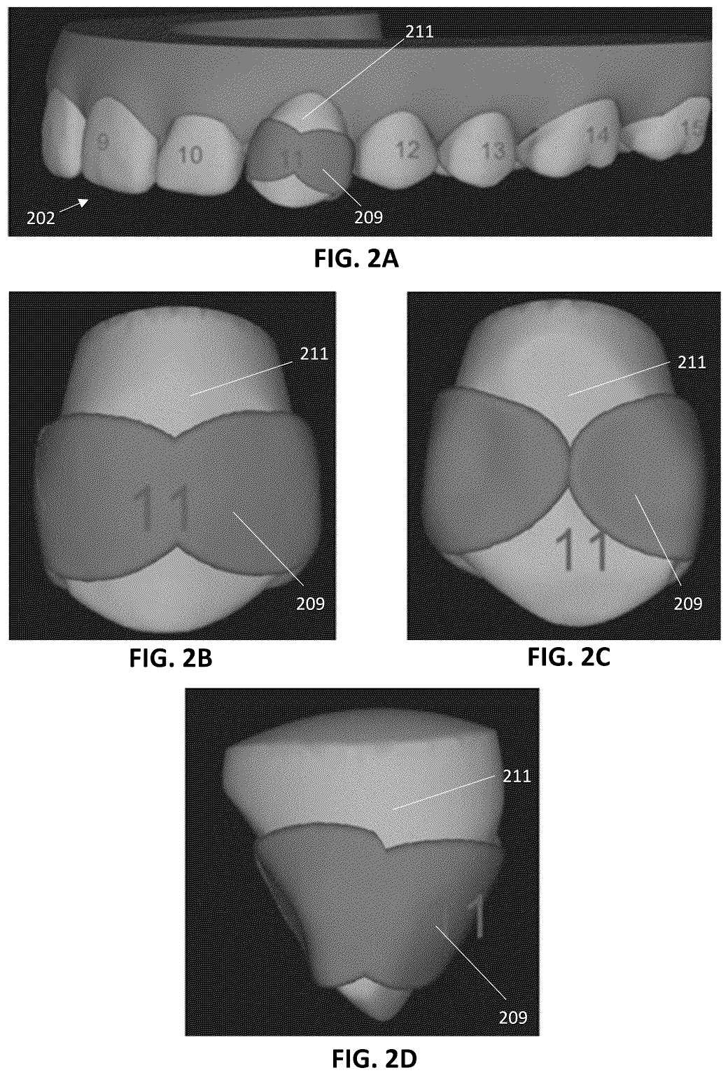

As mentioned, a gap between a tooth and a dental appliance can significantly reduce the normal force, N, between tooth and aligner and, in turn, reduces the friction force ƒ=μN. Another drawback of large gaps between tooth and aligner is that staging becomes less effective; especially in large rotations around the three axes. The radial grips described herein may increase the contact, normal, and friction forces between teeth and aligner. The radial grip may be composed of multiple pressure points all around a tooth in order to tightly grab and hold the tooth such that staging can effectively move the tooth. This is illustrated in FIGS. 2A-2D.

FIG. 2A shows a digital model of a patient's teeth 202 corresponding to a patient's upper arch. In this example, the digital model is segmented into individual teeth, which are shown numbered according to a standard tooth numbering system. Teeth 9, 10, 11, 12, 13, 14 and 15 are shown (corresponding to upper left incisors, 9, 10; canine, 11; premolars 12, 13; and molars 14, 15). In this example a dental appliance is configured to fit over these upper teeth and is further configured to include a radial grip 209 within just one of the tooth-receiving regions of the dental appliance. In order to simplify the view, FIGS. 2A-2D show the teeth with just the radial grip region of the appliance visible; the radial grip is shown gripping the target tooth 211 (e.g., tooth 11, the upper left canine). The appliance is not shown, but fits over the teeth. Ins FIG. 2B-2D the target tooth 211 is shown individually with the radial grip 209 shown gripping the tooth. Thus, FIGS. 2B-2D show the single target tooth (tooth 11) with just the radial grip portion of the dental appliance shown. In practice this dental appliance may be part of a series of dental appliances to move a patient's teeth from an initial configuration into a target configuration. Each dental appliance may be worn for a period of time (e.g., days, weeks, etc.) to move one or more teeth (e.g., the target tooth). FIG. 2B is a buccal view of the target tooth with the radial grip, FIG. 2C is a lingual view of the target tooth and radial grip, and FIG. 2D is a side view of the radial grip and target tooth. As shown, the radial grip extends around and makes contact with the surface of the tooth from around the entire surface, including the buccal and lingual (both anterior and posterior) sides.

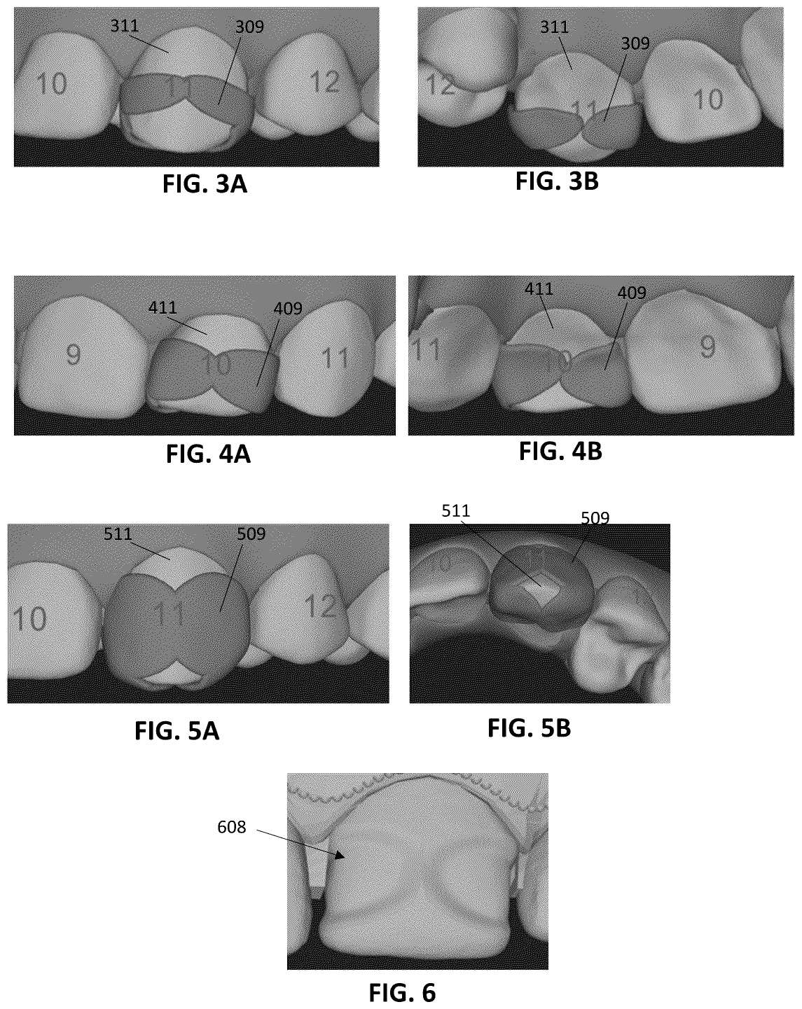

The radial grips described herein may increase the frictional force between the dental appliance and the target tooth, and may therefore be used to apply extrusive forces. For example, the friction force may be increased through increasing normal force, N, coming from the radial grip. This may allow extrusion/intrusion of the tooth relative to the other teeth without requiring the use of attachments on the tooth. FIGS. 3A-3B illustrate an example of the application of an extrusion force on the target tooth 311 by the use of a radial grip 309 region of a dental appliance (not shown). In FIG. 3A the radial grip applies a constrictive force around the tooth and results in a friction force, ƒ, as described above, which is the product of a coefficient of friction and the normal force, N. The use of the radial grip may allow an increase in the normal force beyond what is possible without the constrictive force of the radial grip. In one example, when the radial grip 309 is used and the dental appliance is configured to generate a displacement in the z direction (e.g., displacement in the z direction of 0.3 mm) on tooth 11, the resulting force in the z direction (Fz) is approximately 7.9 N. The same design, including a displacement in the z direction (e.g., of 0.3 mm) without a radial grip results in a force in the z direction of 0 N. FIG. 3A shows a buccal view of an example of tooth 11 showing just the radial grip region of the dental appliance (not visible) in which the dental appliance is further configured (in addition to the constrictive, e.g., radially-inward force) to apply force in the z direction. In FIG. 3B the same tooth 311 and radial grip 309 is shown from the lingual side.

FIGS. 4A-4B illustrate the application of rotation of the canine (tooth 11) using the radial grip. In this example rotation of the tooth (e.g., upper left canine, tooth 11) in the z axis (e.g., z-rotation) may be generated as part of the staging treatment. The radial grip 409 may tightly hold the target tooth 411 and may ensure that there is enough contact between tooth and dental appliance so that z-rotation staging transfers a large amount of energy to the target tooth without resulting in sliding, as shown in FIG. 4A. In this example, the application of a rotational moment to the tooth through the radial grip (in addition to the constrictive force applied by the radial grip) results in a transfer of the rotation moment to the tooth, preventing or limiting slipping of the dental appliance against the tooth. FIG. 4B shows a view from the lingual side of the tooth 411, showing the lingual portion of the radial grip 409. In any of these examples the tooth may be translated in multiple ways, e.g., rotation, displacement in x, y, z, tipping, etc. For example, in FIGS. 4A-4B, the dental appliance may include a radial grip and may be configured to displace the target tooth (tooth 11) both in the z direction (e.g., extrusion) of, e.g., 0.3 mm as well as rotation about the z axis (Rz) of, e.g., about 3 degrees. In this example, the radial grip may transfer a force in the z-direction (Fz) of about 8.07 N and a z-rotational moment of about 47.23 Nmm; if the radial grip is not present, the Fz is approximately −0.01 N and the Mz is approximately 0.19 Nmm.

Any of these methods and apparatuses may also apply anti-tipping or tipping forces through the radial grip, as illustrated in FIGS. 5A-5B. In this example, the target tooth 511 may be moved to correct (or overcorrect) tipping by applying force to the crown of the tooth so that it is displaced at an angle relative to the root of the tooth. In FIGS. 5A-5B for example a radial grip 509 is shown radially contacting the target tooth 511 over much of the crown surface. The MDRC anti-tipping force may be applied through the radial grip 509, which tightly holds the tooth via a constrictive force and provides enough contact between tooth and aligner so that anti-tipping rotation force is applied to the tooth without the dental appliance sliding on the tooth. For example, an anti-tipping force may be applied by applying both y and z translation as well as z rotation; e.g., −0.15 mm in y, 0.15 mm in z, and −5 degrees of Rx may be applied using a radial grip, resulting in a Fy force of −6.26 N, and an Mx of 1.82, as compared with an Fy of −1.93 N and an Mx of 15.9 Nmm when a dental appliance without a radial grip is used (in both cases the Fx in this example may be −2.15 N, an Fz of 7.53 N, an My of −22.45 and an Mz of −0.11 Nmm.

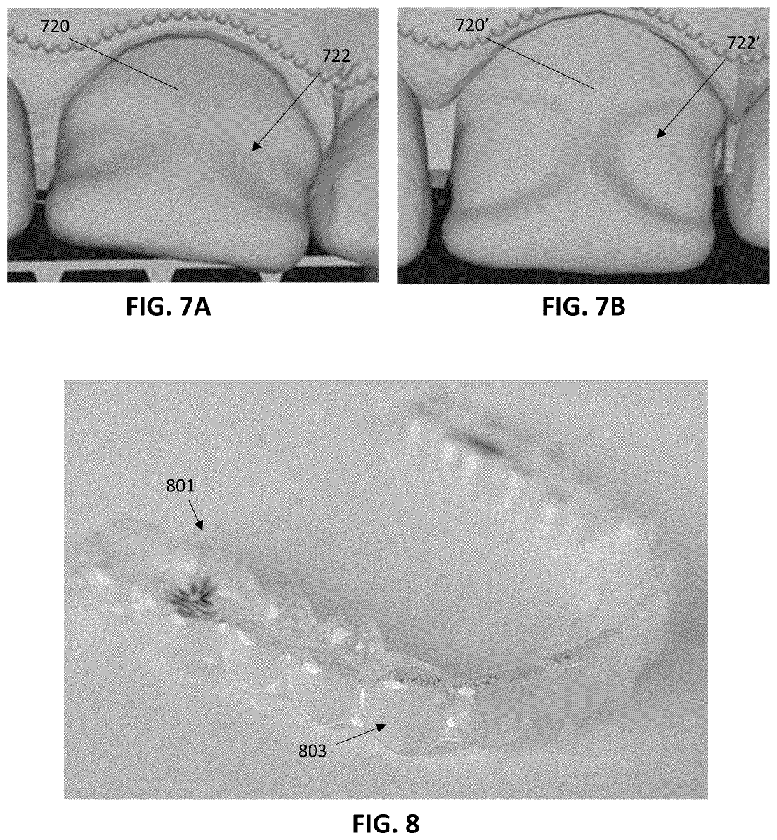

In general, the apparatuses described herein including a radial grip may be fabricated using any appropriate method. For example, the apparatus (e.g., dental appliance) may be fabricated by thermoforming a sheet of polymeric material over a model of the patient's teeth and optionally trimmed to fit over the patient's teeth. The model of the patient's teeth (e.g., upper and/or lower arch) may include the negative impression of the radial grip so that thermoforming over the model result in the shape including the radial grip within the tooth-receiving cavity. The models used for thermoforming may be designed and/or fabricated by direct fabrication, or manually, including making and modifying an imprint of the teeth. For example, FIG. 6 shows a model (e.g., an STL mold) for the dental appliance including the radial grip. Thermoforming a sheet of polymeric material over the model may result in a dental appliance including the radial grip region. In FIG. 6 the model of the tooth may include a recess forming the prominences 608 of the radial grip. FIGS. 7A and 7B illustrate another examples of a model, shown as a digital model of the patient's teeth 720, 720′ including the radial grip 722, 722′. In FIGS. 7A-7B, both digital models include the impression 722 of the radial grip portion of the 3D model (which may be used to form a fabricated model, e.g., SLA model, for forming an aligner. Alternatively a digital model may be used to directly fabricate the aligner using a direct fabrication technique including any of those described herein.

As mentioned, the methods and apparatuses described herein may set or adjust the height (e.g., prominence) of the radial grip relative to the wall of the tooth-receiving cavity (or tooth-receiving region) of the dental appliance. In FIG. 7A the 3D model 720 of the target tooth has a radial grip 722 has a relatively low prominence and rounded shape edge. In FIG. 7B the model 720′ has a radial grip 722′ impression (e.g., as part of the digital and/or SLA model) for forming a dental appliance having a relatively high prominence and a squared shape edge.

In designing the shape, extend and prominence of the radial grip, the prominence of the radial grip, e.g., the height of the radial grip, may be described in relation to the relative separation between the wall(s) of the tooth-receiving region (or cavity) and the target tooth when the device is worn. In general, the radial grip may be in contact with the walls of the tooth circumferentially, so that the radial grip may apply a constrictive force. Thus, the tooth-contacting surfaces of the radial grip may form a continuous or discontinuous structure that has a diameter that is the same size or slightly smaller than the diameter of the target tooth over the region where the radial grip contacts the target tooth when worn in the device. The prominence of the radial grip may be described in comparison with the walls of the other tooth-receiving regions that are configured to receive non-target teeth, including the same tooth on the opposite side of the jaw. In general the radial grip may have one or more tooth-contacting surfaces that are configured to apply a constrictive force.

The height or prominence of the radial grip may be configured to prevent pop-off of the radial grip when the device including the radial grip is worn on the teeth. As mentioned, in some cases, particular where the material forming the radial grip (and/or the rest of the device) may comprise a polymeric material, the radial grip may have a prominence that is between about 0.1 mm and 0.7 mm or less, as prominences greater than 0.7 mm may result in pop-off of the device when worn. In some cases the prominence may be between 0.1 and 0.6 mm, or more preferably between 0.1 and 0.5 mm. The prominence may be measured relative to the wall height of the region that is outside of the radial grip, and/or relative to the wall height of the tooth-receiving cavity for the corresponding tooth on the opposite side of the jaw. In some cases the wall height or prominence of the radial grip may be measured relative to the diameter of the tooth.

The curvature of the edges of the radial grip may also be selected in order to minimize pop-off and to enhance the ease of inserting (and/or removing) the device including one or more radial grips. In some cases the edges of the radial grip may be more or less squared (e.g., less or more rounded). For example, the radial grip may have a radiused or rounded edge. In FIG. 7A the edges of the radial grip 722 (shown in the negative mold impression in FIG. 7A) as compared with the more rounded edges 722′ of the example shown in FIG. 7B. Rounded edges may have a radius of curvature that is approximately equal to the prominence (e.g., between about 0.1 and 0.7 mm) or greater (e.g., 5% greater, 10% greater, 20% greater, 40% greater, 50% greater, 60% greater, 70% greater, 80% greater, 90% greater, 100% greater, etc. than the prominence).

In some cases it may be beneficial to have the tooth-contacting surface of the radial grip extend over a larger surface area of the tooth to increase the frictional force, which may also reduce pop-off. For example, the percentage of the wall(s) of the tooth-receiving cavity that includes the radial grip may be 20% or more (e.g., 25% or more, 30% or more, 35% or more, 40% or more, 45% or more, 50% or more, 55% or more, 60% or more, etc.). In some cases, it may be particularly helpful to limit the total tooth-contacting surface of the radial grip within the tooth-receiving region to be 90% or less (e.g., 85% or less, 80% or less, 75% or less, 70% or less, etc.).

As mentioned, any appropriate method may be used to form the radial grip and/or the device including the radial grip. The radial grip may be integrally formed with the device by thermoforming (e.g., using a model as shown in FIGS. 6 and 7A-7B), or by a direct fabrication technique, including but not limited to 3D printing, injection molding, etc. in some examples the radial grip may be formed separately from the device and inserted into the device (dental appliance, such as the tooth-receiving portions of the dental appliance). In some examples the radial grip may be formed of the same material (e.g., a polymeric material) or a different material than the rest of the dental appliance.

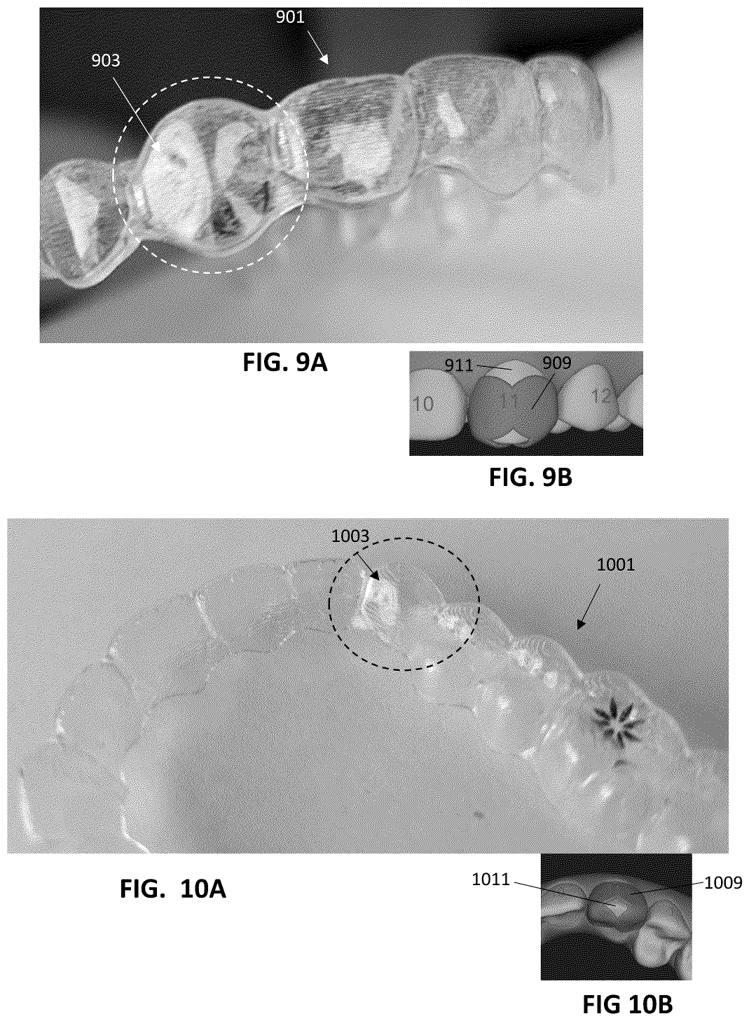

FIG. 8 illustrates another example of a dental appliance 801 including a tooth-receiving portion having a radial grip 803. The radial grip in this example is integrally formed with the dental appliance. FIGS. 9A-9B illustrate another example of a radial grip that is integrally formed with the orthodontic device (e.g., dental appliance), and in particular with one of the tooth-receiving regions. In this example the radial grip within the tooth-receiving region 903 and the rest of the orthodontic appliance (e.g., aligner 901) are formed by thermoforming. The shape of the radial grip 909 is shown in FIG. 9B with the rest of the dental appliance not visible and the radial grip 909 constricting the target tooth 911 (shown as tooth 11 in this example), however other target teeth may be used.

FIG. 10B shows buccal view of a dental appliance 1001 (e.g., orthodontic device) including a radial grip within the tooth-receiving region 1003 (shown within the circled region in FIGS. 9A and 10A). In FIG. 9B the radial grip 1009 is shown without showing the dental appliance, showing the target tooth 1011 being constricted by the radial grip 1009.

### METHODS OF USING

Any of the apparatuses, e.g., devices, systems, etc. described herein may include a radial grip that may be part of the dental appliance (e.g., aligner, palatal expander, retainer, etc.) within the tooth-receiving cavity of the dental appliance. The dental appliance including the radial grip may be used to attach to move a target tooth relative to the patient's other teeth. The movement may include translation in x, y, and/or z directions (including anterior/posterior movement, etc.) and/or rotation, including rotation about the x, y (including tipping), and/or z directions. In particular, these movements may include rotation about the z axis and/or intrusion/extrusion (e.g., movement in the z-axis of the tooth). The axis of the teeth may be determined as known in the art, including based on the long axis of the tooth (from crow to root), which may extend in the z direction. The x-y plane may be the occlusal plane of the tooth.

Any of these apparatuses may be used to move teeth. In some cases the method may be a method of treating a patient. The patient may be treated with a series of dental appliances (e.g., aligners, palatal expanders, etc.) that may incrementally, as part of an ordered treatment plan, move the patient's teeth to a desired target final position. In some cases each stage may be holding (not moving the teeth) or may move one tooth in a predetermined manner based on the treatment plan. The tooth being moved in each stage (bay a particular dental appliance) may be referred to as the target tooth. The tooth-receiving cavity of the dental appliance corresponding to the target tooth may include a radial grip.

The patient may be provided with a dental appliance including a radial grip in one (or in some examples, more than one) tooth-receiving cavity. The dental appliance including the radial grip may then be applied to the patient's teeth by fitting over the patient's teeth. In general, these dental appliances may be patient-removable dental appliances. Applying the dental appliance with the radial grip may include applying the dental appliance over the teeth so that the radial grip applies a constrictive force around the circumference of the target tooth. In some cases the constrictive force is applied in an approximately occlusal plane (e.g., in an x-y plane) or in a plane that is approximately in the occlusal plane (e.g., within about +/−2 degrees, 5 degrees, 10 degrees, 15 degrees, etc.). The radial grip may be any of the radial grips described herein, e.g., may have a prominence of between 0.1 and 0.7 mm relative to the inner wall of the tooth-receiving cavity. The radial grip may contact the crown of the target tooth around the circumference of the tooth to apply a constrictive, gripping force to the circumference of the tooth when the device is worn. In some cases the radial grip contacts the target tooth over 30% or more of the portion of the tooth surface within the tooth-receiving region of the device (e.g., 35% or more, 40% or more, 45% or more, 50% or more, 55% or more, 60% or more, 65% or more, etc. between about 30-80%, etc.).

In addition to applying the constrictive force on the target tooth, the radial grip may also apply a translation and/or rotation force to the target tooth to achieve movement of the tooth or teeth. In some examples the dental appliance and radial grip may be configured to apply a translational movement in x, y and/or z axis and/or may apply a rotation movement in the x, y and/or z axis; these movements may be according to the treatment plan. Prior to fabricating and applying the dental appliance, the treatment plan may be determined, and may account for the radial grip, which may permit movements, including rotational movements (tipping, anti-tipping, z-axis rotation) and/or intrusion/extrusion of the target tooth. As mentioned, the radial grip may be particularly helpful in performing intrusion/extrusion, z-rotation and/or tipping/anti-tipping rotation.

The dental appliance with the radial grip may be worn without any dental auxiliaries (e.g., attachments) coupling the tooth surface to the dental appliance, or without any auxiliaries within the tooth-receiving region of the target tooth. In some cases the dental appliance may be used without any dental auxiliaries at all. Alternatively or additionally, one or more dental auxiliaries may be included in the non-target teeth. A dental auxiliary may be bonded to the tooth and may engage with an engagement region (e.g., pocket, channel, etc.) of the dental appliance when the dental appliance is worn on the patient's teeth.

The dental appliance with the radial grip may be worn for a treatment period (e.g., one day, three days, one week, 10 days, two weeks, three weeks, one month, etc.). The method may include removing the dental appliance (by the patient or the patient's caregiver, e.g., parent), and applying one or more additional dental appliances, at least one of which may include a radial grip for a target tooth (either the same or a different target tooth).

### METHODS OF MAKING

As discussed, the methods described herein may include methods of making any of the apparatuses including radial grips described herein. Method of making may include methods of designing the dental appliance and/or radial grip as well as methods of treatment planning using the radial grip. Treatment planning may include performing one or more of: intrusion/extrusion, tipping, anti-tipping, rotation in the z-axis, etc., using the radial grip to apply a constrictive force to secure the target tooth allowing the application of force by the dental appliance (and through the radial grip) to translate the target tooth.

The methods of making the dental appliances including the radial grip may therefore include one or more treatment stages in which a radial grip is used to apply a constriction force as well as a movement force (e.g., translation and/or rotation) on the target tooth, The dimensions of the radial grip may be determined as part of the method of making, including using software, hardware and/or firmware to plan the treatment plan including accounting for the use of one or more radial grips. For example, the methods may include determining the prominence (e.g., height) of the radial grip, e.g., between a desired range of about 0.1 mm to about 0.7 mm (or within this range), and/or the extend of the radial grip, e.g., contacting surface of the radial grip as a percentage of the inner surface of the interior of the tooth-receiving cavity, (e.g., between a target range, such as 30%-80%, 35%-80%, etc.). The target prominence and/or extent may be determined based on the tooth geometry, e.g., of the target tooth and/or adjacent teeth, and/or based on the materials used to form the radial grip and/or dental appliance.

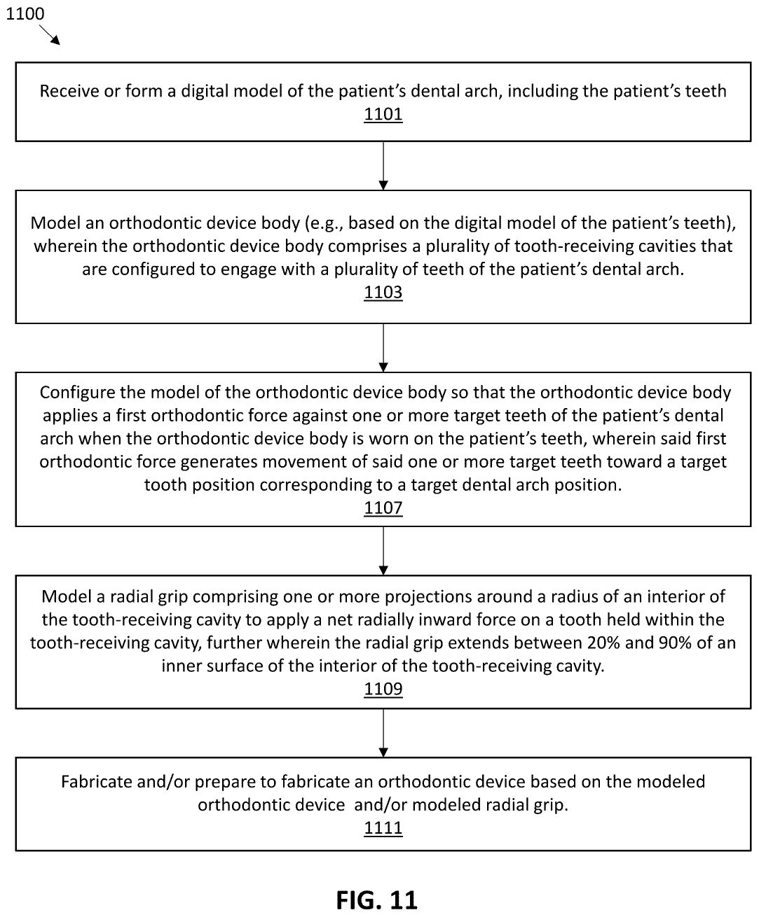

FIG. 11 illustrates one example of a method 1100 of making a dental appliance including a radial grip. In this example the method (which may include any of the steps described above) may include receiving and/or using a digital model of the patient's dental arch, including the patient's teeth 1101. In some cases the method may include forming and/or receiving a dental treatment plan including the dental arch. The treatment plan may be based on the digital model.

The method may include generating a dental appliance to perform the treatment plan, and in particular for executing one or more stages of the treatment plan that move a target tooth. For example, any of these method may also include modeling an orthodontic device body (e.g., based on the digital model of the patient's teeth). The orthodontic device body may include a plurality of tooth-receiving regions (e.g., cavities) that are configured to engage with a plurality of teeth of the patient's dental arch 1103. At least one of these tooth-receiving regions may be configured to receive the target tooth. This step may include the radial grip, or the radial grip may be included in the design at a later step.

In general, the method may include configuring the model of the orthodontic device body so that the orthodontic device body applies a first orthodontic force against one or more target teeth of the patient's dental arch when the orthodontic device body is worn on the patient's teeth. The first orthodontic force(s) may generate movement of said one or more target teeth toward a target tooth position corresponding to a target dental arch position 1107. This movement may be translation (in x, y, z) and/or rotation. As part of this process, or subsequent to this process, the method may include modeling a radial grip as described herein, which may include one or more projections around a radius of an interior of the tooth-receiving cavity to apply a net radially inward (constricting) force on the target tooth when it is within the tooth-receiving cavity. As mentioned, the radial grip may extend between 20% and 90% of an inner surface of the interior of the tooth-receiving cavity 1109 and/or may have a prominence that is between about 0.1 mm and 0.7 mm, and/or may have a radius of curvature of the edge region as described herein.

Once the digital plan for the orthodontic appliance, including the radial grip, is completed, the dental device may be fabricated 1111. Fabrication include and/or may be the formation of a digital file with the digital design of the orthodontic appliance. The digital model may be configured as a file that may bread by 3D printing technology. In some cases fabrication may include forming the dental appliance and/or a series of dental appliance. Thus, any of these methods may include fabricating and/or preparing to fabricate an orthodontic device based on the modeled orthodontic device and/or modeled radial grip.

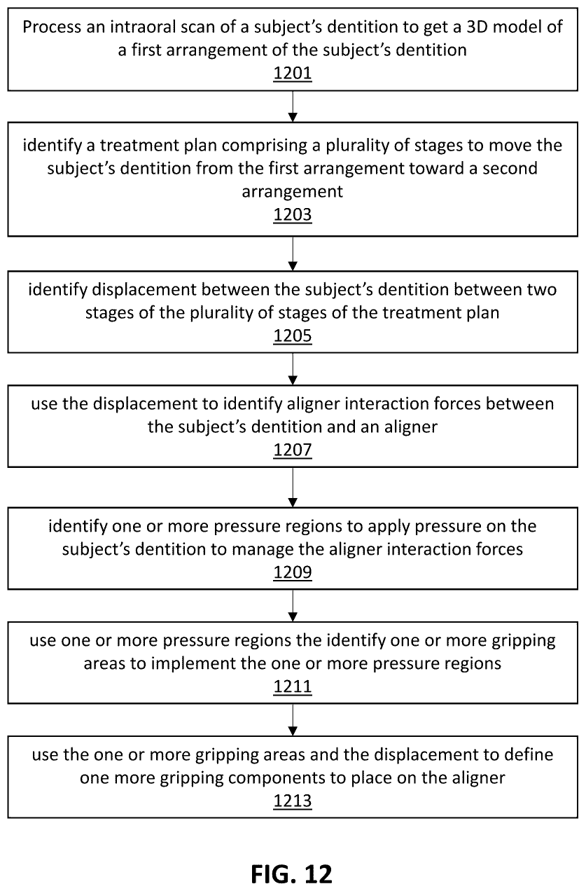

FIG. 12 illustrates another example of a method of forming one or more (e.g., a series) of dental appliances including a radial grip region as described herein. For example, as shown in FIG. 12, the method may include processing an intraoral scan of a subject's dentition to get a 3D model of a first arrangement of the subject's dentition 1201. Any of these methods may include receiving the intraoral scan of a subject's dentition.

Processing may include receiving and/or forming the 3D model of the dentition. The dentition may be in a first (e.g., initial) arrangement.

Any of these methods may then include identifying a treatment plan comprising a plurality of stages to move the subject's dentition from the first arrangement toward a second arrangement 1203. These methods may include identifying a displacement between the subject's dentition between two stages of the plurality of stages of the treatment plan 1205. The stages may be sequential stages. This step may identify one or more teeth that are moving in rotation (e.g., tooth rotation) and intrusion/extrusion movements that may benefit from the radial grip regions described herein. The treatment plan may provide a plurality of intermediate arrangements to move the subject's dentition from the first arrangement toward the second arrangement.

Any of these methods may also include identifying the second arrangement (e.g., target arrangement) of the subject's dentition, e.g., using a manipulation of the 3D model.

The method may further include using the displacement to identify aligner interaction forces between the subject's dentition and an aligner 1207. Aligner interaction forces may include contact forces, normal forces, friction forces, or some combination thereof.

The method may further identify one or more pressure regions to apply pressure on the subject's dentition to manage the aligner interaction forces 1209. Managing the aligner interaction forces may include achieving the aligner interaction forces sufficient to grip and move the tooth. In some example, managing the aligner interaction forces comprises reducing the aligner interaction forces.

The method may then include using one or more pressure regions the identify one or more gripping areas to implement the one or more pressure regions 1211. In general, the gripping areas may be modeled as one or more bands around the specific tooth.

Any of these methods may include using the one or more gripping areas and the displacement to define one more gripping components to place on the aligner 1213. Using the one or more gripping areas and the displacement to define one more gripping components may include modifying the displacement of the specific tooth receiving cavity.

In any of the methods described herein the method may include fabricating one or more aligners including the gripping component (e.g., gripping areas) as describe above. Fabricating the aligner may refer to and/or may include providing instructions to make an aligner with the one or more gripping component. Fabricating may include generating an aligner corresponding to one of the two stages having the one or more gripping areas to achieve the displacement. Fabricating may include 3D printing and/or thermoforming (e.g., over a mold or physical model of the teeth). The gripping component may be integral to the tooth receiving cavity of the aligner. In some examples the gripping component comprises a region of increased contact between the subject's dentition and the aligner.

All publications and patent applications mentioned in this specification are herein incorporated by reference in their entirety to the same extent as if each individual publication or patent application was specifically and individually indicated to be incorporated by reference. Furthermore, it should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of”' the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13,and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An orthodontic device comprising:
a body comprising a plurality of tooth-receiving cavities having a first shape corresponding to a target dental arch position, wherein the body applies a first orthodontic force against one or more target teeth of a dental arch of a patient, wherein said first orthodontic force generates movement of said one or more target teeth toward a target tooth position corresponding to the target dental arch position;
wherein a tooth-receiving cavity of the plurality of tooth receiving cavities includes a radial grip comprising one or more projections arranged around a radius of an interior of the tooth-receiving cavity configured to apply a net radially inward force on a tooth held within the tooth-receiving cavity, further wherein the radial grip extends between 20% and 90% of an inner surface of the interior of the tooth-receiving cavity.

2. The device of claim 1, wherein the one or more projections has a prominence relative to the inner surface of between 0.1 mm and 0.7 mm.

3. The device of claim 1, wherein the one or more projections has a prominence relative to the inner surface of between 0.2 mm and 0.6 mm.

4. The device of claim 1, wherein the radial grip comprises a band extending around the interior of the tooth-receiving cavity.

5. The device of claim 1, wherein the radial grip comprises a plurality of projections arranged symmetrically around the interior of the tooth-receiving cavity.

6. The device of claim 1, wherein the one or more projections arranged around the radius of the interior of the tooth-receiving cavity are on a buccal side and a lingual side of the interior of the tooth-receiving cavity.

7. The device of claim 1, wherein the radial grip extends between 30% and 80% of the inner surface of the interior of the tooth-receiving cavity.

8. The device of claim 1, wherein the radial grip has a rounded edge,

9. The device of claim 1, wherein the radial grip comprises a textured surface.

10. The device of claim 1, wherein the first orthodontic force is applied in addition to the net radially inward force.

11. An orthodontic device comprising:
a body comprising a plurality of tooth-receiving cavities having a first shape corresponding to a target dental arch position, wherein the body applies a first orthodontic force against one or more target teeth of a dental arch of a patient, wherein said first orthodontic force generates movement of said one or more target teeth toward a target tooth position corresponding to the target dental arch position;
wherein at least one tooth receiving cavity of the plurality of tooth receiving cavities includes a radial grip comprising one or more projections arranged around a radius of an interior of the at least one tooth-receiving cavity to apply a net radially inward force on a tooth held within the at least one tooth-receiving cavity, further wherein the radial grip extends between 30% and 80% of an inner surface of the interior of the at least one tooth-receiving cavity, further wherein the one or more projections has a prominence relative to the inner surface of between about 0.1 mm and 0.7 mm.

12. A method of forming an orthodontic device for a patient, the method comprising:
receiving or forming a digital model of the patient's dental arch, including the patient's teeth;
modeling an orthodontic device body, based on the digital model of the patient's teeth, the orthodontic device body comprising a plurality of tooth-receiving cavities that are configured to engage with a plurality of teeth of the patient's dental arch;
configuring the model of the orthodontic device body so that the orthodontic device body applies a first orthodontic force against one or more target teeth of the patient's dental arch when the orthodontic device body is worn on the patient's teeth, wherein said first orthodontic force generates movement of said one or more target teeth toward a target tooth position corresponding to a target dental arch position;
modeling a radial grip comprising one or more projections around a radius of an interior of the tooth-receiving cavity to apply a net radially inward force on a tooth held within the tooth-receiving cavity, further wherein the radial grip extends between 20% and 90% of an inner surface of the interior of the tooth-receiving cavity; and
fabricating the orthodontic device.

13. The method of claim 12, wherein modeling the radial grip comprises modifying the model of the orthodontic device body to include the model of the radial grip.

14. The method of claim 12, wherein fabricating the orthodontic device comprises exporting a digital file comprising the model of the orthodontic device including the radial grip.

15. The method of claim 12, wherein fabricating the orthodontic device comprises forming the orthodontic device by three-dimensional (3D) printing.

16. The method of claim 12, wherein the one or more projections has a prominence relative to the inner surface of between 0.1 mm and 0.7 mm.

17. The method of claim 12, wherein the one or more projections has a prominence relative to the inner surface of between 0.2 mm and 0.6 mm.

18. The method of claim 12, wherein the radial grip is arranged as a band extending around the interior of the tooth-receiving cavity.

19. The method of claim 12, wherein the radial grip is arranged as a plurality of projections positioned symmetrically around the interior of the tooth-receiving cavity.

20. The method of claim 12, wherein the one or more projections arranged around the radius of the interior of the tooth-receiving cavity are on a buccal side and a lingual side of the interior of the tooth-receiving cavity.

21. The method of claim 12, wherein the radial grip extends between 30% and 80% of the inner surface of the interior of the tooth-receiving cavity.

22. The method of claim 12, wherein the radial grip has a rounded edge.

23. The method of claim 12, wherein the radial grip comprises a textured surface.

24. The method of claim 12, wherein the first orthodontic force is applied in addition to the net radially inward force.
